(19) United States
(12) Patent Application Publication
(10) Pub. No.: US 2006/0080704 A1
(43) Pub. Date: Apr. 13, 2006

(54) Method and system for transmitting a video message to television set

(75) Inventors: Emmanuel Le Huerou, Saint-Quay Perros (FR); Michael Pontiggia, Lannion (FR); Bertrand Berthelot, Rennes (FR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: FRANCE TELECOM SA, Paris (FR)

(21) Appl. No.: 11/245,474

(22) Filed: Oct. 7, 2005

(30) Foreign Application Priority Data
Oct. 7, 2004 (FR) 04 10578

(51) Int. Cl. G08B 5/22; H04N 7/10

(52) U.S. Cl. 725/34; 340/7.52; 340/7.2; 340/7.46; 340/7.55; 725/32

(57) ABSTRACT

Data are transmitted to a television receiver by creating audiovisual stimuli and a video message that convey these stimuli, has an identifier of its recipient, and is in the form of a stream of digital data. The stream of digital data is converted into an analogue signal which is compatible with a predefined input format for the television receiver. As a result an individual can transmit, to a recipient of his choice, a text message with which there has been previously associated audiovisual stimuli which are specifically and expressly intended for the recipient.

### RELATED APPLICATIONS

The present application is based on, and claims priority from, French Application Number 04 10578, filed Oct. 7, 2004, the disclosure of which is hereby incorporated by reference herein in its entirety.

### FIELD OF THE INVENTION

The present invention relates to a method and a system for transmitting data which make it possible to restore visual stimuli by means of a television receiver.

### BACKGROUND OF THE INVENTION

Television receivers traditionally make it possible to restore visual and auditory stimuli which are defined by analogue signals received by said television receiver, which analogue signals are usually produced either by a decoder designed to receive information from a cable network or an antenna for receiving electromagnetic waves, or directly by such an antenna, and are compatible with a predefined input format for the television receiver in question, for example a PAL, SECAM or NTSC format (abbreviations known to the person skilled in the art for the expressions “Phase Alternate Line”, “Sequential Colour with Memory” and “National Television Systems Committee”, respectively).

In line with a tendency which has appeared relatively recently in the state of the art, these traditional television receivers, which can be found in many homes in industrialized countries and are perfectly integrated in cultural terms in such countries, are used in the context of new applications as terminals for receiving images and sounds which are initially transmitted in the form of digital signals, in particular data signals which are able to be conveyed by a communication network of the Internet type. In such an application, the digital data signals are converted into analogue signals by a conversion device arranged upstream of the television receiver, any operation of defining, storing and transmitting said data prior to the conversion being carried out by digital means for acquiring, processing, storing and transmitting data.

In the current state of the art, a person who owns a television receiver which is connected to the Internet network via a conversion device can thus receive “live”, in the sense of “in synchronism with the transmission”, a range of television programmes which will thus be sent to him in digital form by a wired connection, rather than in an analogue manner by a microwave radio link which is more sensitive to climatic and/or electromagnetic variables, it furthermore not being possible for an analogue signal to be restored upon receipt, contrary to what can be done in respect of a digital signal, any loss of integrity of which can be detected and corrected by its receiver.

Other applications for transmitting digital audiovisual programmes consist in sending to a recipient who owns a television receiver, following the formulation of a specific request by this recipient, a stream of digital data representative of an audiovisual work selected by this recipient, for example a cinematographic work. Depending on the nature of the request, and in particular depending on the size of a sum of money paid by the recipient as an accompaniment to his request, this recipient could for example be authorized to store the stream of data with a view to being able to read it a number of times in a manner asynchronous to the source of the work, that is to say at any time other than the moment of transmission of the data stream, on condition for example of paying a greater sum than a sum which would allow him to read the data stream only once in a manner synchronous to the source of the work, that is to say without any possibility of storing this stream.

However, the applications mentioned above currently do not make it possible to use television receivers other than for restoring predefined programmes and works in a uniform manner for a multitude of potential recipients, and do not make it possible for an individual to send to the television receiver of a recipient of his choice an audiovisual message which would be specifically intended for this recipient, for example having been especially conceived and created as a function of characteristics specific to said recipient, whom the sender may know or assume to exist.

### SUMMARY OF THE INVENTION

One of the aims of the invention is to make possible such a personalization of the programmes which are able to be transmitted to a television receiver via a communication network of digital type.

To this end, a method in accordance with the introductory paragraph is characterized, according to a first aspect of the invention, in that it includes:

a step of creating at least one set of digital data representative of audiovisual stimuli,

a step of creating a text message, referred to as a video message, said message being intended to be associated with said set of data and to be provided with at least one identifier which defines at least one recipient of said message,

a step of identifying the recipient by means of his identifier,

a step of transmitting the video message to said recipient in the form of a stream of digital data, and

a step of converting said stream of digital data into an analogue signal which is compatible with a predefined input format for said television receiver.

The invention makes it possible for an individual to send to a single recipient or to a group of recipients of his choice, each recipient being specifically and expressly defined by his identifier, for example an address of the “e-mail” type or an address of the “URL” type (abbreviations known to the person skilled in the art for the expressions “electronic mail” and “Universal Resource Location”, respectively), a text message with which there will have been previously associated the set of digital data representative of audiovisual stimuli specifically and expressly intended for this recipient. The set of data may be associated with the text message in the form of an attached file, but also by means of a hypertext link which specifies a location at which the set of data has been made available to the recipient or recipients.

A method such as that described above will furthermore advantageously include an alert step, designed to be carried out after a transmission step, during which alert step a stimulus is produced at the recipient with a view to informing him that a video message has been transmitted to him.

Such an alert step will make it possible to inform the recipient of a video message, in a manner which is not very intrusive, that such a message has been sent to him and is available for him, but without causing an untimely display of the entire message on the screen of the recipient's television receiver. The alert stimulus could be produced at the recipient on his television receiver in the form of an image, optionally associated with a sound or with a melody. As an alternative or in addition, the alert stimulus could also be produced on a terminal which is separate from the television receiver, such as a mobile telephone for example which the recipient would also own, and the number of which would also be known to the sender of the message and specified by the latter, or else extracted from a database in which said number will have been previously stored alongside the identifier of the recipient. The alert stimulus could then be notified by a ringing or vibration produced by this mobile telephone, but also by an image if this mobile telephone has a sufficiently high-performance screen.

According to one specific embodiment of this aspect of the invention, the alert step preferably includes the following sub-steps:

a sub-step of extracting, from said set of data, a subset of data representative of a first image preceding any other image contained in the video message,

a sub-step of converting the data contained in the subset thus extracted into an alert signal which is compatible with said input format, and

an alert sub-step, during which said first image is displayed on the recipient's television screen prior to any displaying of an image chronologically posterior to the first image.

The extraction, conversion and alert sub-steps defined above make it possible to draw the recipient's attention to the arrival of a video message which is intended for him, but without causing an untimely display of the entire message on the screen of the recipient's television receiver, under conditions which could be annoying or disruptive for this recipient or those around him at the moment when the video message reaches him. On seeing the first image displayed during the alert sub-step, the recipient will be able to determine whether he wishes to view the video message immediately or rather delay such an operation until more favourable conditions prevail. In some embodiments of the invention, execution of the extraction, conversion and alert sub-steps defined above could be posterior to a prior transmission of an alert stimulus on a terminal which is separate from the recipient's television receiver, for example a mobile telephone.

Thus, in one variant of the particular embodiment described above, any displaying of images chronologically posterior to the first image is subordinate to the prior execution by the recipient of a display command step subsequent to an alert step.

Moreover, in order to limit the volume of telecommunication generated by implementation of the invention, a method described above will preferably include a step of converting the set of data associated with the video message into a compressed format, this conversion step being designed to be carried out prior to the transmission step.

According to another of its aspects, relating to its implementation in terms of equipment, the invention furthermore relates to a system for transmitting data which makes it possible to restore visual stimuli by means of a television receiver, which system includes:

means for creating at least one set of digital data representative of audiovisual stimuli,

means for creating a text message, referred to as a video message, said message being intended to be associated with said set of data and to be provided with at least one identifier which defines at least one recipient of said message,

means for identifying the recipient by means of his identifier,

means for transmitting the video message to said recipient in the form of a stream of digital data, and

means for converting said stream of digital data into an analogue signal which is compatible with a predefined input format for said television receiver.

### BRIEF DESCRIPTION OF THE DRAWING

The aforementioned features of the invention, and also others, will emerge more clearly from reading the following description of one example of embodiment, said description being given with reference to the appended drawings, in which:

FIG. 1 is a block diagram which shows a telecommunications system according to one particular embodiment of the invention,

FIG. 2 is a flowchart which shows means for creating a video message, said means being contained in this telecommunications system, and

FIG. 3 is a flowchart which shows processing and interface means which are contained in this telecommunications system.

### DETAILED DESCRIPTION OF THE DRAWING

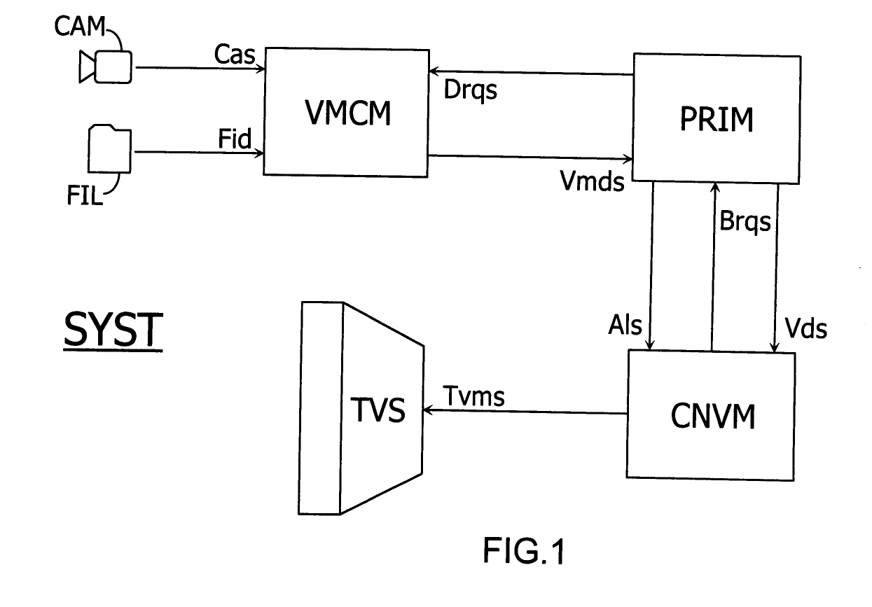

FIG. 1 schematically shows a telecommunications system which makes it possible for an individual to send to a television receiver TVS available to a recipient of his choice an audiovisual message which is specifically intended for this recipient. To this end, the telecommunications system SYST includes:

means for creating a set of digital data representative of audiovisual stimuli, including in this example a camera CAM designed to generate a signal Cas representative of such stimuli, which will then constitute a video sequence,

means for creating VMCM a text message, referred to as a video message Vmds, said message being intended to be associated with said set of data and to be provided with at least one identifier which defines a recipient of said message,

means for identifying the recipient by means of his identifier, in this case included in processing and interface means PRIM,

means for transmitting the video message to said recipient in the form of a stream of visual data Vds, and

means for converting CNVM said stream of audiovisual data Vds into an analogue signal Tvms which is compatible with a predefined input format for the television receiver TVS.

The conversion means CNVM could consist of a device of the “decoder box” type (this type also being known to the person skilled in the art as a “set-top box”), integrating a decoder of digital audiovisual signals, for example in accordance with the MPEG2 or MPEG4 standard (abbreviations derived from the expression known to the person skilled in the art “Motion Picture Expert Group”), and a central processing unit which is able to implement an Internet browser, making it possible for said conversion means CNVM to communicate via the Internet network with the processing and interface means PRIM.

The camera CAM could consist of any item of digital photographic equipment, for example a digital camcorder, a camera of the webcam type or a camera integrated in a mobile telephone. In other embodiments of the invention, the camera CAM and the creation means VMCM could be integrated within one and the same device. The set of digital data could furthermore have been previously generated and recorded by a camera and then sent to the creation means VMCM in the form of a file containing prerecorded data.

In accordance with the above description, the creation means VMCM are moreover able to receive data Fid defined by at least one text file FIL, in which the sender of the audiovisual data will have defined, in addition to any content of an accompanying message, the recipient for whom he has generated or selected said audiovisual data, which definition will be carried out for example by means of an address of the “e-mail” type or an address of the URL type.

The video message Vmds will preferably be stored by the creation means VMCM and kept available for the processing and interface means PRIM, so as to avoid saturating the latter by the spontaneous production of streams which will not be requested or desired by their recipients. In such a case, which is provided for in the system SYST described here, a stream of digital data Vmds will actually be sent by the creation means VMCM to the processing and interface means PRIM only on condition that a request Drqs has previously been sent to this effect by said processing and interface means PRIM to the creation means VMCM.

Moreover, in the particular embodiment described by the present figure, the processing and interface means PRIM include means for producing a digital alert signal Als which carries data contained in a subset defining the first image contained in the stream of visual data Vmds, which digital signal is designed to be converted and transmitted in an analogue format which is compatible with the input format of the television receiver TVS by the conversion means CNVM prior to the signal Tvms, before any displaying of an image chronologically posterior to the first image, of which the data conveyed by the signal Als are representative.

The extraction, conversion and alert procedure defined above will make it possible to draw the recipient's attention to the arrival of a video message which is intended for him, but without causing an untimely display of the entire message on the screen of the television receiver TVS, under conditions which could be annoying or disruptive for this recipient or those around him at the moment when the video message reaches him. On seeing the first image displayed during the alert step, the recipient will be able to determine whether he wishes to view the video message immediately or rather delay such an operation until more favourable conditions prevail, or even decide to archive or delete this message without even having seen the rest of the video sequence contained therein.

The recipient could make his choice known to the conversion means CNVM via a wireless link, for example of the infrared, Bluetooth or Wi-Fi type. Other tools for interaction, such as control keys arranged on the front of the device which constitutes the conversion means CNVM, could furthermore be made available to the recipient so as to make it possible for him to make his choice known under the circumstances described above.

Once the recipient has made known to the conversion means CNVM his wish to receive the entire video message, said conversion means CNVM will transmit a broadcast request signal Brqs to the processing and interface means PRIM, which will send back by way of return, in its entirety, a stream of video data Vds which contains not only the first image already broadcast in the alert message Als, but also all the images chronologically posterior to said first image and also, where appropriate, any soundtrack associated with said images.

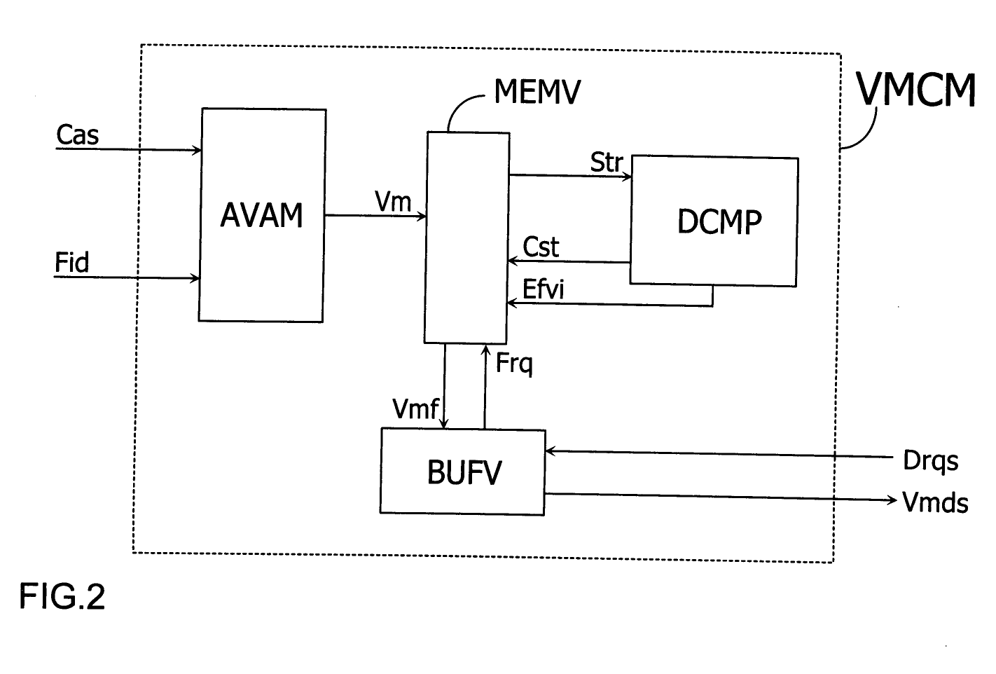

FIG. 2 schematically describes one possible embodiment of the means for creating VMCM video messages Vmds. These means comprise a module for acquiring AVAM a set of digital data conveyed by the signal Cas and representative of audiovisual stimuli, in this example a video sequence. The acquisition module AVAM is furthermore designed to receive data Fid previously contained in a text file in accordance with the above description, and to combine the set of data conveyed by the signal Cas with the text data Fid so as to create a video message which is referred to as the initial video message Vm. The creation means VMCM furthermore include a memory module MEMV which is designed to store the video message Vm thus created.

In this particular embodiment of the invention, the creation means VMCM also include a module for compressing DCMP the audiovisual data, which is able to produce, in addition to a compressed output stream Cst(W) corresponding to a preselected input audio/video stream Str from the memory means MEMV, an extracted file Efvi comprising data representative of the first image extracted from said input stream Str and defined as preceding any other image contained in said input stream Str. The compression format will be selected from the formats which can be easily transmitted via Internet, for example the “Windows Media” format (the name “Windows Media” is protected as a trademark and is known to the person skilled in the art to denote a particular data compression format).

The compressed output stream Cst(W), accompanied by the extracted file Efvi, can then replace the set of digital data originally contained in the initial video message Vm so as to form, in association with the text message defined by the data Fid, a new file Vmf which contains a video message referred to as the final video message, which file Vmf will then be stored in the memory means MEMV and could be produced with a view to transmission in the form of a stream of visual data Vmds to its recipient via a provision module BUFV.

As mentioned above, such a provision of the stream of visual data Vmds will preferably be carried out only after receipt of a data request signal Drqs by the provision module BUFV, which will send this signal back in the form of a file request Frq to the memory means MEMV, after which, and only then, the stream of visual data Vmds will be produced by said memory means MEMV via the provision module BUFV.

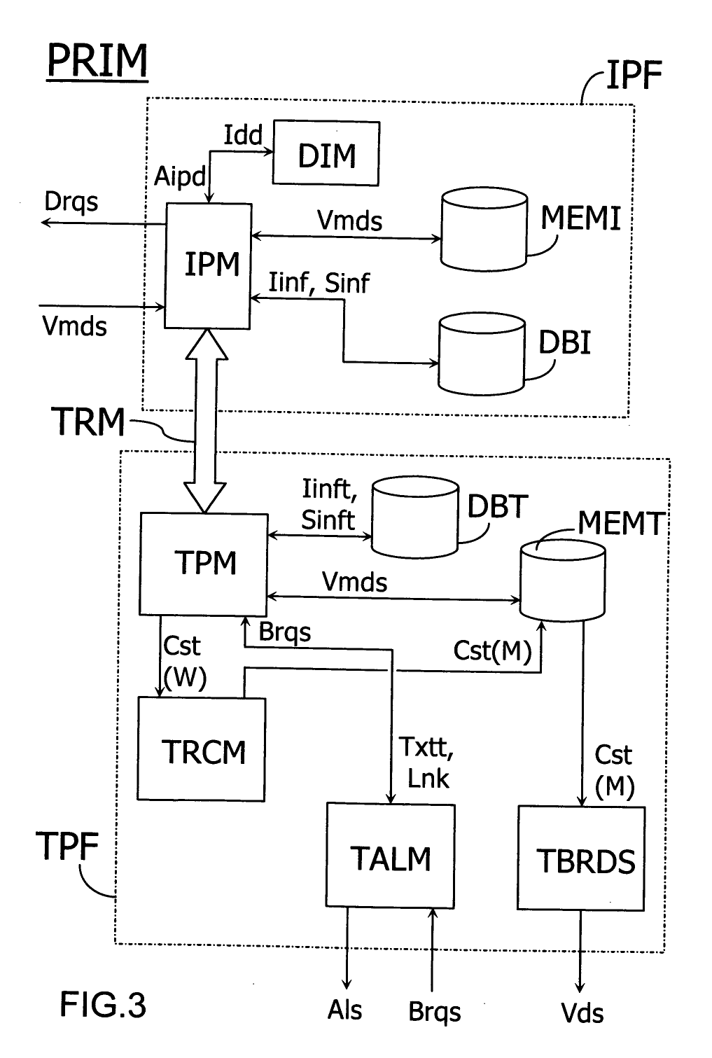

FIG. 3 shows in a highly schematic manner one possible embodiment of the processing and interface means PRIM, which may be represented in the form of a transmission platform IPF and a reception platform TPF, which platforms are connected to one another by transmission means TRM which could for example implement the Internet network, and also optionally other communication networks such as wired or wireless telephone networks and wired or wireless local area networks of the Wi-Fi type. The transmission platform IPF may thus be considered as essentially similar to the Internet world, whereas the reception platform TPF is for its part essentially similar to the world of traditional television, the transmission means TRM serving to connect these two worlds.

The transmission platform IPF comprises an interface module IPM which is designed to transmit data request signals Drqs and to receive video messages Vmds in return. This interface module IPM may consist of a network server, commonly referred to as a “Web server”, which, in collaboration with a recipient identification module DIM, for example a domain name server which is able to produce an Internet address Aipd specific to a recipient defined by his identifier Idd extracted from a video message Vmds, is able to route video messages Vmds to the recipients identified in said messages Vmds. The transmission platform IPF furthermore comprises a memory space MEMI which will consist for example of a hard disk contained in the aforementioned Web server, and which is designed to store the video messages Vmds following receipt. A database DBI, which is also included in the transmission platform IPF, furthermore makes it possible to store and update intrinsic information Iinf such as the identity of the sender of the message, that of its recipient, the nature (purely video or combined with an audio track) of the sequence defined by the set of digital data associated with the video message in question, etc. The database DBI also permits storage and updating of status information Sinf such as the statuses “sent”, “not read”, “read”, etc. relating to the messages Vmds stored in the memory space MEMI. The database DBI could for example be a database of the “MySQL” type which is installed on the Web server mentioned above (the name “MySQL” is protected as a trademark and is known to the person skilled in the art to denote a particular database model).

The reception platform TPF comprises an interface and management module TPM which is designed to send back to the transmission platform IPF any broadcast request Brqs and to receive video messages Vmds from said transmission platform IPF. This interface and management module TPM could be composed of scripts executed on a Web server (PHP).

The reception platform TPF furthermore comprises a memory space MEMT which may consist for example of a hard disk contained in the aforementioned Web server (PHP) and which is designed to store the video messages Vmds following receipt. A database DBT, which is also included in the reception platform TPF, furthermore makes it possible to store and update intrinsic information Iinft such as the identity of the sender of the message, that of its recipient, the nature (purely video or combined with an audio track) of the sequence defined by the set of digital data associated with the video message in question, etc. The database DBT also permits storage and updating of status information Sinft such as the statuses “sent”, “not read”, “read”, etc. relating to the messages Vmds stored in the memory space MEMT. The database DBT could for example be a database of the “MySQL” type, and could optionally be combined with the database DBI contained in the transmission platform described above.

The reception platform TPF furthermore comprises a code conversion module TRCM which is able to receive a stream of data Cst(W) which will have been previously compressed into a format that can be easily transmitted via Internet, for example the “Windows Media” format, and to code-convert this stream of data into a stream Cst(M) which is compatible with the input format of the conversion means described above, for example the MPEG2 format or the MPEG4 format.

The reception platform TPF finally comprises an alert transmission module TALM which is able to produce a digital alert signal Als which carries data defining the first image of a video message, said alert signal Als optionally being able to convey a text message Txtt and/or a hypertext link Lnk which asks the recipient of the alert signal Als to request the broadcasting of an audiovisual sequence stored at a location defined by said hypertext link. The recipient can then formulate a broadcast request Brqs, which the alert transmission module TALM can receive and transmit to the interface and management module TPM, following which a broadcast module TBRDS that is also contained in the reception platform TPF will produce, for the conversion means described above, the stream of data Cst(M) identified in the broadcast request Brqs and extracted from the memory space MEMT.

The invention described above will make it possible for any individual with suitable equipment to transmit, to a television receiver available to a recipient of his choice, an audiovisual message which will be specifically intended for this recipient, and the latter may optionally have the capability of authorizing, postponing or refusing the broadcasting of said video message on his television receiver.

1. A method of transmitting data, by using a television receiver to restore visual stimuli which method includes:
creating at least one set of digital data representative of audiovisual stimuli,
creating a text message, referred to as a video message, said message being associated with said set of data and including at least one identifier which defines at least one recipient of said message,
identifying the recipient by using an identifier for the recipient,
transmitting the video message to said recipient as a stream of digital data, and
converting said stream of digital data into an analogue signal which is compatible with a predefined input format for said television receiver.

2. Method according to claim 1, further including an alert step that is performed after the transmission step, during the alert step altering the recipient that a video message has been transmitted to him by stimulating the recipient.

3. Method according to claim 2, wherein the alerting step includes:
extracting, from said set of data, a subset of data representative of a first image preceding all other images in the video message,
converting the data in the extracted subset into an alert signal which is compatible with said input format, and
performing the alerting step while said first image is displayed on the recipient's television screen prior to any displaying an image that chronologically after to the first image.

4. Method according to claim 3, wherein displaying of images chronologically after the first image is subordinate to the prior execution by the recipient of a display command step subsequent to the alerting step.

5. Method according to claim 1, further including the step of compressing said set of data prior to the transmission step.

6. A system for performing the steps of claim 1.

7. Method according to claim 2, further including the step of compressing said set of data prior to the transmission step.

8. Method according to claim 3, further including the step of compressing said set of data prior to the transmission step.

9. Method according to claim 4, further including the step of compressing said set of data prior to the transmission step.

10. System for transmitting data for enabling visual stimuli to be restored by a television receiver, which system includes:
a process arrangement for (a) creating at least one set of digital data representative of audiovisual stimuli, (b) a text message, referred to as a video message, said message being intended to be (i) associated with said set of data and (ii) provided with at least one identifier for defining at least one recipient of said message, and (iii) identifying the recipient by using his identifier,
a transmitter for transmitting the video message to said recipient in the form of a stream of digital data, and
a converter for converting said stream of digital data into an analogue signal which is compatible with a predefined input format for said television receiver.
